(19) United States
(12) Patent Application Publication
(10) Pub. No.: US 2025/0096712 A1
(43) Pub. Date: Mar. 20, 2025

(54) AUTOMATIC TUNING FOR BLDC MOTOR FIELD-ORIENTED CONTROLLER

(71) Applicant: Allegro MicroSystems, LLC, Manchester, NH (US)

(72) Inventors: Simon Kalombo, Rozzano (IT); Kamyar Khosravi, Austin, TX (US); Masahira Kurihara, Edinburgh (GB)

(73) Assignee: Allegro MicroSystems, LLC, Manchester, NH (US)

(21) Appl. No.: 18/830,847

(22) Filed: Sep. 11, 2024

Related U.S. Application Data
(60) Provisional application No. 63/582,914, filed on Sep. 15, 2023.

(51) Int. Cl. H02P 21/34; H02P 21/18; H02P 21/22

(52) U.S. Cl. CPC H02P 21/34; H02P 21/18; H02P 21/22

(57) ABSTRACT

Methods and apparatus for automatic tuning of parameters for field-oriented control (FOC) of a BLDC motor with a controller with user input. Automatic tuning can include measuring electrical parameters comprising Phase resistance (Rₛ), Phase inductance (Lₛ), and Back-electromotive force (BEMF) constant (Kₑ). Automatic tuning can further include tuning of ac alignment and start-up processing, tuning of a current closed loop, and tuning of a speed closed loop.

### CROSS REFERENCE TO RELATED APPLICATIONS

The present application claims the benefit of U.S. Provisional Patent Application No. 63/582,914, filed on Sep. 15, 2023, which is incorporated herein by reference.

### BACKGROUND

Circuits to control and drive brushless DC (BLDC) electric motors are known. Conventional BLDC motor control techniques may employ BEMF (back emf) information for position estimation, however, BEMF information is not available at zero speed, for example, at motor startup. A conventional startup technique is to drive the motor in open-loop without position estimation (e.g., align and go for example), which may cause reverse rotation during startup. In addition, this technique may increase startup time if a relatively conservative startup profile is chosen or render motor startup unreliable if an aggressive startup profile is chosen.

Some three-phase BLDC motor startup techniques can use sensors, such as Hall effect elements, to detect position and/or speed of the motor for use by the controller. These types of systems can be referred to as “sensor-based” systems. One motor type that generally employs a sensor-based control system is a permanent magnet synchronous motor (PMSM).

In other motor control systems, separate sensors are not used to detect the motor position and/or speed and thus, such systems are sometimes referred to as “sensorless systems.” Such systems include electronic circuitry to estimate motor position and/or speed.

Some sensorless motor control systems implement Field Oriented Control (FOC) in which the control causes the stator and rotor magnetic fields to be orthogonal to each other to achieve the maximum electromagnetic torque. In the automotive industry, motor control is often sensorless control due to reliability and cost. Also, there is a need for quieter motor operation for electric vehicles (EV) and hybrid electric vehicles (HEV). Motor acoustic noise generated in combustion engines is less problematic than in electric vehicles. However, quiet motor operation is required especially when a combustion engine is stopped.

### SUMMARY

Example embodiments of the disclosure provide methods and apparatus for automatic tuning of a Field Oriented Control (FOC) controller for a brushless DC (BLDC) electric motor. In example embodiments, a user input parameter information and motor parameters are measured, such as Phase resistance (Rₛ), Phase inductance (Lₛ), and Back-electromotive force (BEMF) constant (Kₑ). In embodiments, processing can include tuning of various types, such as tuning of the ac alignment and start-up algorithms, tuning of the current closed loop, and/or tuning of the speed closed loop.

In example embodiments, tuning processing executes in parallel on embedded hardware (HW) and a host computer graphical user interface (GUI) to enhance the performance and modularity. Communication between platforms is achieved through UART communication protocol with use of the DMA peripheral. A GUI frontend provides user interface necessary for AT algorithm initial settings, as described more fully below. Backend of the GUI serves as computational and data evaluation mode for parameter and tuning settings computation. Procedures to measure, collect and send the data are implemented on the HW. Tuning of the speed closed loop, implemented directly on the HW, works as real-time online tuning with optimization, as described more fully below.

In one aspect, a method of automatically tuning a controller for a field-oriented control (FOC) electric motor, comprises: receiving user input for parameters for tuning the controller; measuring phase resistance and phase inductance of the motor; and automatically tuning the controller for at least one type of tuning based on the user input and the measured phase resistance and phase inductance of the motor.

A method can further include one or more of the following features: the at least one type of tuning includes alignment tuning, the at least one type of tuning includes startup tuning, the at least one type of tuning includes current closed loop tuning, the at least one type of tuning includes speed closed loop tuning, estimating a BEMF constant Ke for the motor using at least one of the parameters received as user input, measuring the phase resistance and phase inductance of the motor prior to tuning a current loop for the motor, and estimating the constant Ke during tuning of a speed loop of the motor, the receiving user input for the parameters includes receiving a rated motor speed, the receiving user input for the parameters includes receiving a rated current for the motor, the receiving user input for the parameters includes a DC bus voltage for the motor, the receiving user input for the parameters includes receiving a resistance of a shunt resistor, the receiving user input for the parameters includes receiving an acceleration factor for the motor, the receiving user input for the parameters includes receiving a deceleration factor for the motor, the at least one type of tuning includes alignment tuning, startup tuning, current closed loop tuning, and speed closed loop tuning, measuring the phase resistance includes injecting a DC voltage into a d-axis of the motor at a standstill and measuring d-axis current, measuring the phase inductance includes measuring motor current response to injection of a sine waveform into a d-axis, the sine waveform has a plurality of non-harmonic frequencies, the at least one type of tuning includes alignment tuning, wherein the alignment tuning is a function of rated current of the motor, and wherein the alignment tuning includes tuning of an AC alignment frequency, the at least one type of tuning includes startup tuning, and wherein the start up tuning includes tuning a startup start frequency and a startup end frequency, the at least one type of tuning includes current closed loop tuning, and further including using performance assessment criteria (PAC) for comparing an ideal current closed loop response with a current closed loop response having varying parameters, the at least one type of tuning includes speed closed loop tuning, and further including determining a gain factor for speed control, using a cost function to determine the gain factor, the cost function is configured to find the gain factor for PI control, and or voltage injection is used to estimate the phase resistance and the phase inductance of the motor.

In another aspect, a system to automatically tune a controller for a field-oriented control (FOC) electric motor, comprises: memory and at least one processor configured to: receive user input for parameters for tuning the controller; measure phase resistance and phase inductance of the motor; and automatically tune the controller for at least one type of tuning based on the user input and the measured phase resistance and phase inductance of the motor.

A system can further include one or more of the following features: the at least one type of tuning includes alignment tuning, the at least one type of tuning includes startup tuning, the at least one type of tuning includes current closed loop tuning, the at least one type of tuning includes speed closed loop tuning, estimating a BEMF constant Ke for the motor using at least one of the parameters received as user input, measuring the phase resistance and phase inductance of the motor prior to tuning a current loop for the motor, and estimating the constant Ke during tuning of a speed loop of the motor, the receiving user input for the parameters includes receiving a rated motor speed, the receiving user input for the parameters includes receiving a rated current for the motor, the receiving user input for the parameters includes a DC bus voltage for the motor, the receiving user input for the parameters includes receiving a resistance of a shunt resistor, the receiving user input for the parameters includes receiving an acceleration factor for the motor, the receiving user input for the parameters includes receiving a deceleration factor for the motor, the at least one type of tuning includes alignment tuning, startup tuning, current closed loop tuning, and speed closed loop tuning, measuring the phase resistance includes injecting a DC voltage into a d-axis of the motor at a standstill and measuring d-axis current, measuring the phase inductance includes measuring motor current response to injection of a sine waveform into a d-axis, the sine waveform has a plurality of non-harmonic frequencies, the at least one type of tuning includes alignment tuning, wherein the alignment tuning is a function of rated current of the motor, and wherein the alignment tuning includes tuning of an AC alignment frequency, the at least one type of tuning includes startup tuning, and wherein the start up tuning includes tuning a startup start frequency and a startup end frequency, the at least one type of tuning includes current closed loop tuning, and further including using performance assessment criteria (PAC) for comparing an ideal current closed loop response with a current closed loop response having varying parameters, the at least one type of tuning includes speed closed loop tuning, and further including determining a gain factor for speed control, using a cost function to determine the gain factor, the cost function is configured to find the gain factor for PI control, and or voltage injection is used to estimate the phase resistance and the phase inductance of the motor.

### BRIEF DESCRIPTION OF THE DRAWINGS

The foregoing features of this disclosure, as well as the disclosure itself, may be more fully understood from the following description of the drawings in which:

FIG. 1 is a block diagram of a user interface for a system having embedded hardware configured to execute processing for tuning of a FOC controller for a brushless DC (BLDC) electric motor;

FIG. 2A is a graphical representation of a d-axis voltage reference and FIG. 2B is a graphical representation of measured d-axis current for determining a safety voltage;

FIG. 3A is a graphical representation of a d-axis voltage reference and FIG. 3B is a graphical representation of measured d-axis current for obtaining phase resistance;

FIG. 4A is a graphical representation of a d-axis voltage reference and FIG. 4B is a graphical representation of measured d-axis current for obtaining phase inductance;

FIG. 5A is a graphical representation of a startup frequency reference and FIG. 5B is a graphical representation of a q-axis voltage reference;

FIG. 6 is a block diagram of a current control scheme;

FIG. 7 is a graphical representation of an integral transfer function frequency response;

FIG. 8 is a graphical representation of controller performance for ramp speed references;

FIG. 9 is a schematic representation of gain vector recreation;

FIG. 10 is a flow diagram of an example sequence of steps for automatic tuning by a controller;

FIG. 11 is a schematic representation of an FOC controller having automatic tuning for controlling a motor; and

FIG. 12 is schematic representation of an example computer that can perform at least a portion the processing described herein.

### DETAILED DESCRIPTION

In example embodiments of the disclosure, automatic tuning (AT) can include measuring motor electrical parameters, such as Phase resistance (Rₛ), Phase inductance (Lₛ), and/or back-electromotive force (BEMF) constant (Kₑ), tuning of the ac alignment and start-up algorithms, tuning of the current closed loop, and/or tuning of the speed closed loop.

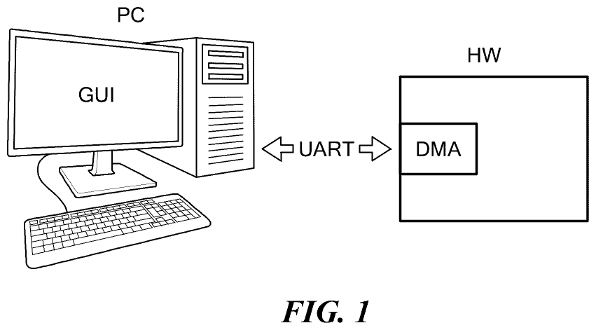

In embodiments, tuning processing executes in parallel on the embedded hardware (HW) and host computer's graphical user interface (GUI) to enhance the performance and modularity. Communication between platforms may be achieved through UART communication protocol with use of the DMA peripheral, as shown in FIG. 1. The GUI frontend provides a user interface necessary for automatic tuning initial settings, as explained below, and backend of the GUI serves as computational and data evaluation mode for parameter and tuning settings computation. Procedures to measure, collect and send the data are implemented on the HW (hardware). Tuning of the speed closed loop, implemented directly on the HW, works as real-time online tuning with optimization (will be explained in appropriate section).

The GUI allows the user to interact with the automatic tuning processing. User input provides parameters for the automatic tuning algorithm execution. Example parameters include:
Rated motor speed (ω_{rated} [rad/s])
   Maximum safe operational speed of the motor
   Used as a safety speed threshold.
Rated current (I_{rated} [A])
   Maximum safe operational current of the motor.
   Used for parameter tuning and as a safety threshold.
DC bus voltage (VBB [V])
   Power supply voltage
Shunt resistor (Rₛₕᵤₙₜ [ohm])
   Resistance value of the current shunt sensing resistor.
Acceleration factor (AccFac [Hz/s])
   Demanded rotor acceleration.
Deceleration factor (Decfac [Hz/s])
   Demanded rotor deceleration

In embodiments, a backend of the GUI controls the processing of the automatic tuning and provides computations for the parameter measurement and current loop tuning. In example embodiments, parameter measurements, such as Phase resistance (Rs) and Phase inductance, are measured together prior to current loop tuning (necessary parameters for current loop tuning). BEMF constant Ke is measured while speed loop tuning is executing (while rotor is moving).

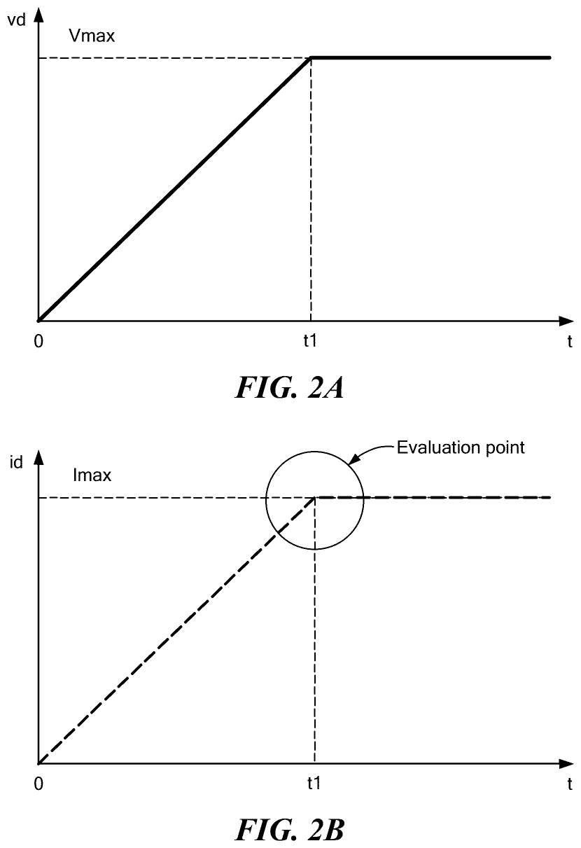

A voltage reference serves as a safety voltage threshold for the other parameter measurement. Voltage Vd is injected in a fixed step while current Id is measured, as shown in FIGS. 2A and 2B. Processing is continuous until measured current hits the max set threshold. FIG. 2A shows a D-axis voltage reference and FIG. 2B D-axis measured current.

I_{d}(t1)=I_{Max}=>Vₘₐₓ=V_{d}(t1)

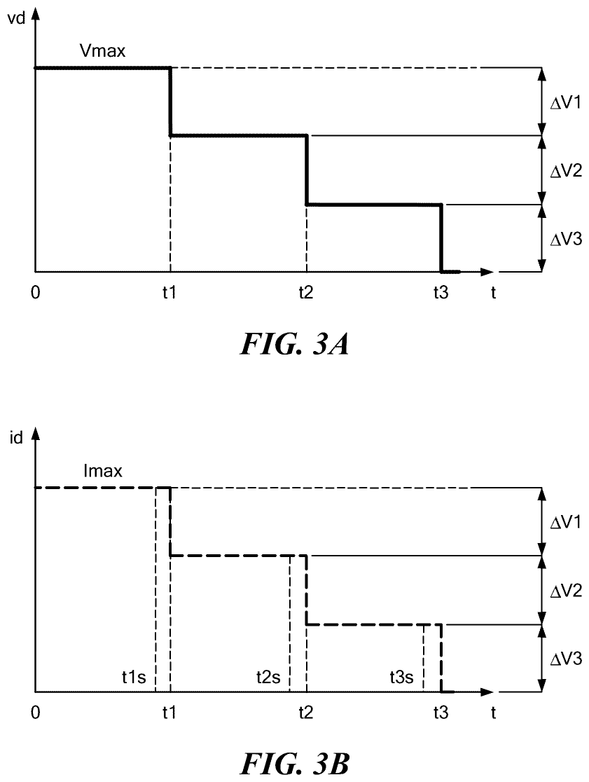

In embodiments, phase resistance is obtained by injecting DC voltage steps (FIG. 3A) into d-axis of a standstill AC rotary machine while d-axis current is measured (FIG. 3B). FIG. 3A shows a D-axis voltage reference and FIG. 3B shows D-axis measured current.

In the illustrated embodiment, a total of 4 d-axis voltage levels may be injected with corresponding current measurements. Currents are measured delayed to the voltage change to avoid transient response and measure in steady state. For each voltage level, d-axis current is sampled and averaged.

$${\overline{I}}_{d x} ( {t}_{x} ) = \frac{1}{n} {Σ}_{i = 0}^{n} {i}_{d i} ( {t}_{x s} + i \cdot {T}_{s} ) ,$$

where Ī_{dx}(tₓ) is average of d-axis current i_{di} at time tₓ and n is number of samples Tₛ. Phase resistance is then computed from Ohm's law per below:

$$Δ {V}_{1} = \overline{{V}_{d} ( 0 )} - \overline{{V}_{d} ( {t}_{1} )} \qquad Δ {I}_{1} = \overline{{I}_{d} ( 0 )} - \overline{{I}_{d} ( {t}_{1} )}$$

$$Δ {V}_{2} = \overline{{V}_{d} ( {t}_{1} )} - \overline{{V}_{d} ( {t}_{2} )} \qquad Δ {I}_{2} = \overline{{I}_{d} ( {t}_{1} )} - \overline{{I}_{d} ( {t}_{2} )}$$

$$Δ {V}_{3} = \overline{{V}_{d} ( {t}_{2} )} - \overline{{V}_{d} ( {t}_{3} )} \qquad Δ {I}_{3} = \overline{{I}_{d} ( {t}_{2} )} - \overline{{I}_{d} ( {t}_{3} )}$$

$${R}_{s} = \frac{1}{2 n} {\sum }_{i = 1}^{n} \frac{Δ {V}_{i}}{Δ {I}_{i}}$$

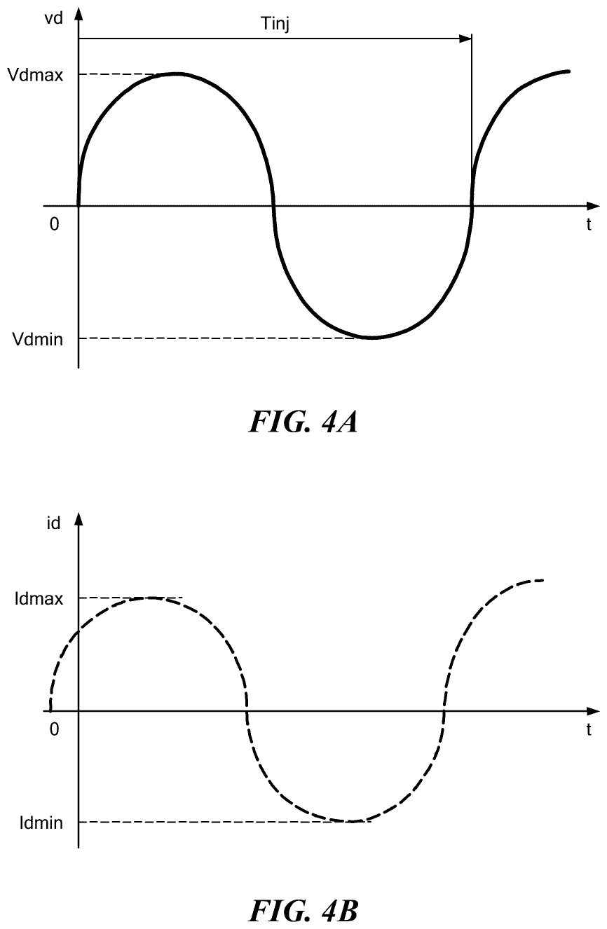

In example embodiments, phase inductance Lₛ is obtained by the d-axis high frequency sine voltage waveform injection of a standstill AC rotary machine while current response is measured. FIG. 4A shows a D-axis voltage reference signal and FIG. 4B shows D-axis measured current.

In the illustrated embodiment, a voltage signal is injected with the frequency ωᵢₙⱼ=2πfᵢₙⱼ=2π1/Tᵢₙⱼ with amplitude of A=V_{dmax}−V_{dmin}/2 Minimum and maximum values of d-axis current I_{dmin}, I_{dmax} are captured to compute impedance Z with use of Rₛ estimated before. Zₘₐₓ=V_{dmax}/I_{dmax}Zₘᵢₙ=V_{dmin}/I_{dmin}

$$\vert {Z}_{max , min} \vert = \sqrt{{{R}_{s}^{2} + j ω {L}_{s Max , Min} )}^{2}}$$

$${L}_{s Max , Min} = \frac{\sqrt{{Z}_{max , min}^{2} - {R}_{s}^{2}}}{2 {ω}_{i n j}}$$

$${L}_{s} = \frac{{L}_{s Max} + L {s}_{Min}}{2}$$

For increasing accuracy, inductance may be measured n times with n different injection non-harmonic frequencies for validating individual values and potentially discarding incorrect values.

Estimation of the BEMF constant Ke is done based on the model of the SPMSM and FOC controller variable knowledge. By introducing q-axis machine voltage equation

$${v}_{q} = {R}_{s} {i}_{q} + {L}_{q} \frac{{di}_{q}}{dt} + N ω ( {i}_{d} {L}_{d} + {ψ}_{PM} )$$

and by making assumptions that a motor is running at constant speed (di_{q}/dt=0) and the motor is type of SPMSM driven with i_{d}=0, one obtains:

$${v}_{q} = {R}_{s} {i}_{q} + N ω {ψ}_{PM}$$

$${K}_{e} = N {ψ}_{PM} = \frac{\overline{{V}_{q}} - {R}_{s} \overline{{I}_{q}}}{ω}$$

where V̅_{q}=1/nΣᵢ₌₁ⁿv_{qi}, Ī_{q}=1/nΣᵢ₌₁ⁿv_{qi}, N is number of pole pairs, w is an electrical rotor frequency, WPM is a flux linkage of a permanent magnets.

In embodiments, ac alignment, which refers to a step in which the motor is spinning with a fixed speed and duty cycle, includes tuning as a function of rated current I_{rated}. Example parameters to be tuned include:
s16FreqRef—AC alignment initial frequency with which the motor is rotated.
s16PeakDuty—Percentage amount of applied voltage, from available PWM scheme utilization,
u32CountNum—Time of alignment (number of TPWM).

In an embodiment, s16FreqRef is set to constant 8 (=0.8 Hz).

In embodiments, s16PeakDuty is defined below as:

$${I}_{align} = 0.1 \cdot {I}_{rated}$$

$$s 16 PeakDuty = \frac{{I}_{align}}{{I}_{Max}} \cdot 100 ∈ 〈 3 ; 99 〉 \%$$

where I_{Max}=1/SAG/Rₛₕᵤₙₜ SAG is sampling amplifier gain and Rₛₕᵤₙₜ is sensing shunt resistor resistance.

In embodiments, an example startup tuning process, during which the motor spins from an initial defined frequency and linearly ramps to a defined end frequency, includes tuning as a function of rated current I_{rated}. Example parameters to be tuned include:
s16StartFreq—startup start frequency,
s16EndFreq—startup end frequency,
s32NumbOfSteps—startup length (number of TPWM),
s16VoltRefStart—starting voltage value
s16VoltRef—ending voltage value

In one particular embodiment, the s16StartFreq parameter is set to constant equal to Alignment. s16FreqRef, e.g., s16StartFreq=Alignment. s16FreqRef=8

The s16EndFreq parameter may be set to constant for tuning.

s16EndFreq=288

The s32NumbOfSteps parameter may be set to constant for tuning.

s32NumbOfSteps=20 000

The s16VoltRefStart parameter may be set equal to the Alignment. s16PeakDuty, e.g., s16VoltRefStart=Alignment. s16PeakDuty

The s16VoltRef parameter may be defined as:

$${I}_{align} = 0.8 \cdot {I}_{rated}$$

$$s 16 VoltRef = \frac{{I}_{start}}{{I}_{Max}} \cdot 100 ∈ 〈 7 ; 99 〉 \%$$

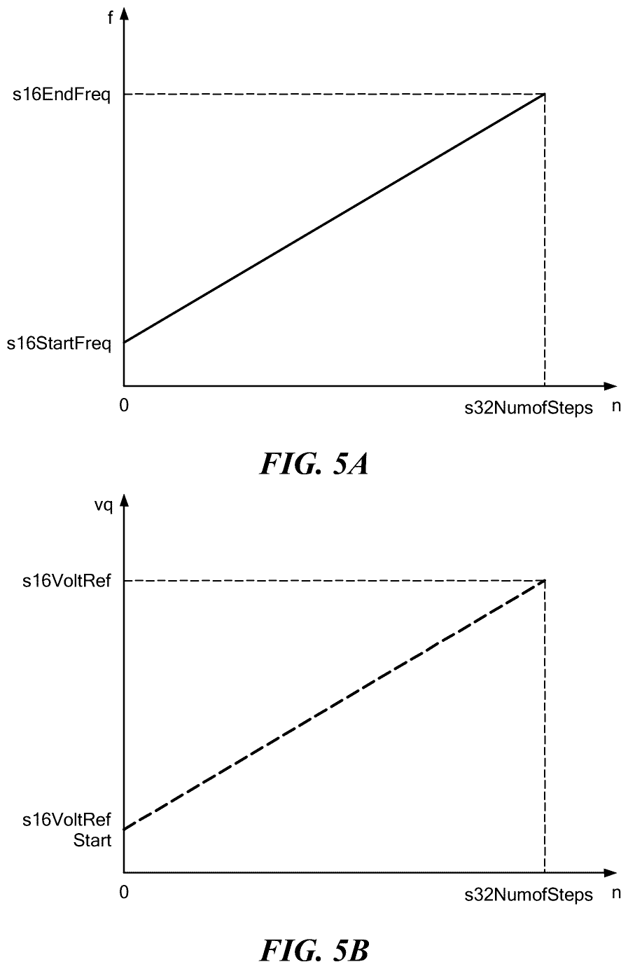

FIG. 5A shows an example Startup frequency reference and FIG. 5B shows an example Q-axis voltage reference.

In embodiments, current closed loop tuning, which refers to a process in which the parameters that are used to control motor phase current are tuned, can be performed. Current controller tuning is an iterative process based on Performance Assessment Criteria (PAC) evaluation. To that end, a reference (ideal) response needs to be created.

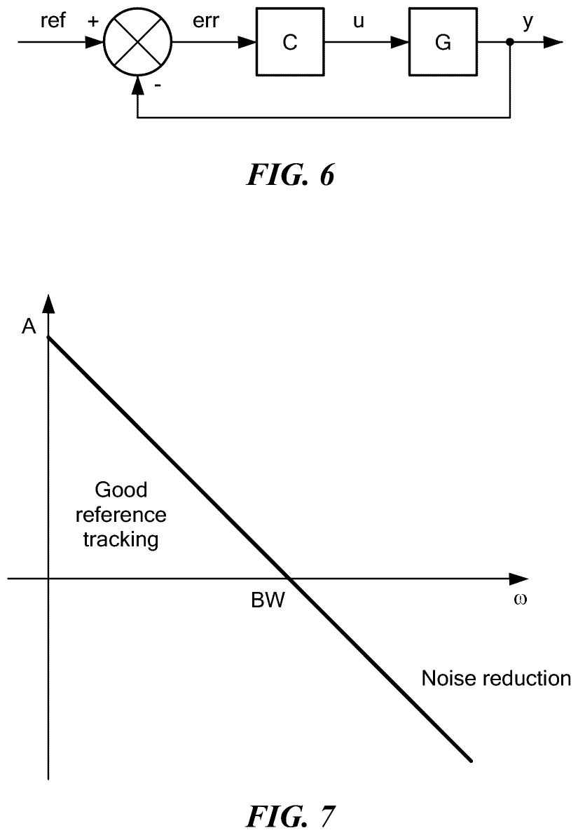

Loop shaping method may be used to create a current controller reference response with respect to a specified bandwidth. By introducing a closed loop current control scheme, as shown in FIG. 6, where G=1/Lₛ·s+Rₛ, err=ref−y, s represents a Laplace operator and u is the output of the current controller C. Integral response is used for designing an ideal current controller transfer function.

From the Integral transfer function frequency response shown in FIG. 7, the controller has a good reference tracking for the frequency range within the bandwidth (BW) and any signal beyond the defined bandwidth (BW), will be suppressed. The goal is to shape the integral desired response to be equal to the open loop transfer function (FIG. 6).

$$\begin{matrix}C \cdot G = {G}_{Desired} \to C \\ = \frac{{G}_{Desired}}{G} \\ = \frac{\frac{{ω}_{BW}}{S}}{\frac{1}{{L}_{s} \cdot S + {R}_{s}}}\end{matrix}$$

$$S = \frac{G \cdot C}{1 + G \cdot C}$$

By evaluation of the closed loop transfer function S, an ideal response of the current controlled with respect to the specified bandwidth is obtained. With this arrangement, robustness of the controller can be evaluated by knowing the transfer function.

An optimal selected gain can be set for matching the desired controller response to the extent practically possible. Processing is designed to find that optimum gain set.

By computing linearized and reduced PMSM closed loop current control model (FIG. 6) with varying controller gain settings, responses of corresponding settings are stored.

$$A = [ \begin{matrix}- \frac{{R}_{s}}{{L}_{s}} & 0 \\ 0 & \frac{{R}_{s}}{{L}_{s}}\end{matrix} ] ,$$

$$B = [ \begin{matrix}\frac{1}{{L}_{s}} & 0 \\ 0 & \frac{1}{{L}_{s}}\end{matrix} ] ,$$

$$C = [ \begin{matrix}1 & 0 ] ,\end{matrix}$$

$$X = [ \begin{matrix}{v}_{q} \\ {v}_{d}\end{matrix} ]$$

$$\dot{X} = AX + Bu$$

$$Y = CX$$

where A, B, C are PMSM state-space model matrices, X is a state vector, Y is a output vector and u is a control vector. The control vector u is equal to the output of the PI current controller and could be implemented by the function of the desired reference response state vector.

u=PiController(Yref,X)

Performance of every set is evaluated by PAC.

An Integral absolute error (IAE) can be defined as:

$$IAE ( Kp , Ki ) = {\int }_{0}^{∞} \vert {y}_{ref} - y \vert dt$$

An Integral time absolute error (IAE) can be defined as:

$$ITAE ( Kp , Ki ) = {\int }_{0}^{∞} t \vert {y}_{ref} - y \vert dt$$

It is understood that added time penalizes later errors.

An Integral square error can be defined as:

$$ISE ( Kp , Ki ) = {\int }_{0}^{∞} {( {y}_{ref} - y )}^{2} dt$$

where the “square” penalizes larger errors.

An Integral time square error can be defined as:

$$ITSE ( Kp , Ki ) = {\int }_{0}^{∞} {t ( {y}_{ref} - y )}^{2} dt$$

Large later errors are penalized.

In an example embodiment, a performance value is represented by the cost function below, where Wx indicates respective weights:

$$J ( Kp , Ki ) = {W}_{1} IAE + {W}_{2} ITAE + {W}_{3} ISE + {W}_{4} ITSE$$

A controller with the minimum value of the cost function matches the reference as well as possible based on cost function weights setting. It is understood that any suitable weighting scheme can be used.

In speed closed loop tuning, due to the absence of mechanical parameters and their difficult estimation, speed loop tuning is implemented directly on the hardware, Initial speed loop I controller gain Ki_{LUT} is set up from a look-up table (LUT) based on the Acceleration/Deceleration factor, which is used to define motor speed increase/decrease slew rate. After initial gain is set, hardware real-time optimization begins the search to find t most optimal speed controller gain setting. For that purpose, a gain vector of five elements is created GainVec=[Ki_{LUT}−2 Ki_{LUT}−1 Ki_{LUT} Ki_{LUT}+1 Ki_{LUT}+2].

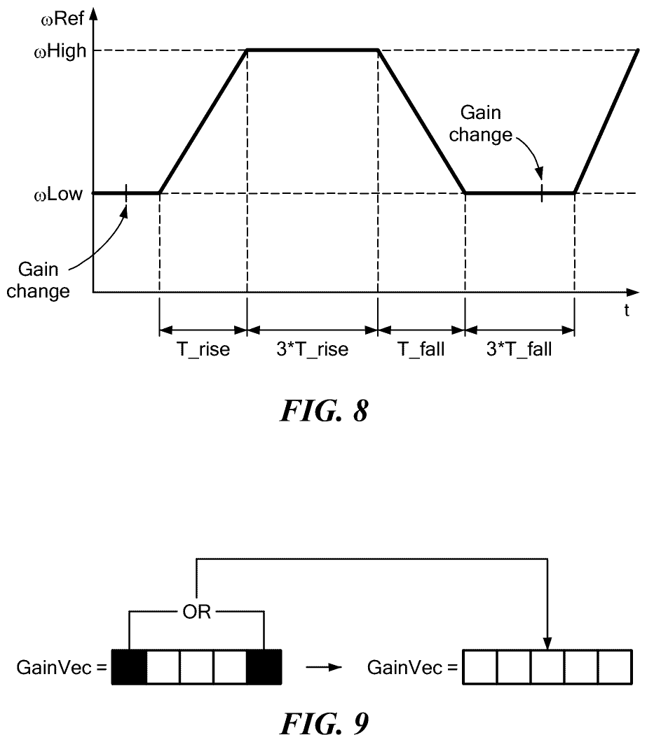

For each GainVec element, controller performance is evaluated with ramp a speed reference as shown in FIG. 8.

$${T}_{rise} = AccFac \vert {ω}_{High} - {ω}_{Low} \vert [ s ]$$

$${T}_{fall} = DecFac \vert {ω}_{High} - {ω}_{Low} \vert [ s ]$$

In an example embodiment, controller gain performance is evaluated by IAE, ISE and integral absolute gradient (IAG).

$$IAE ( Ki ) = {\int }_{0}^{∞} \vert {ω}_{ref} - ω \vert dt$$

$$ISE ( Ki ) = {\int }_{0}^{∞} {( {ω}_{ref} - ω )}^{2} dt$$

$$IAG ( Ki ) = {\int }_{0}^{∞} \vert ω ( k ) - ω ( k - 1 ) \vert dt$$

Criteria are computed for every element in GainVec and normalized,

$${IAE}_{xn} = \frac{{IAE}_{x}}{max ( IAE )}$$

$${ISE}_{xn} = \frac{{ISE}_{x}}{max ( ISE )}$$

$${IAG}_{xn} = \frac{{IAG}_{x}}{max ( IAG )}$$

And evaluated with an example cost function:

$$J = W \cdot ( {IAE}_{n} + {ISE}_{n} ) + ( 1 - W ) \cdot {IAG}_{n}$$

Minimum value (optimum) of the cost function J corresponds to “best” speed controller gain setting. In situations when optimal gain is equal either to GainVec(first) or GainVec(last), the whole speed loop tuning process is repeated with the gain being set as initial (Ki_{LUT}) and new GainVec is created with a method, such as that shown in FIG. 9.

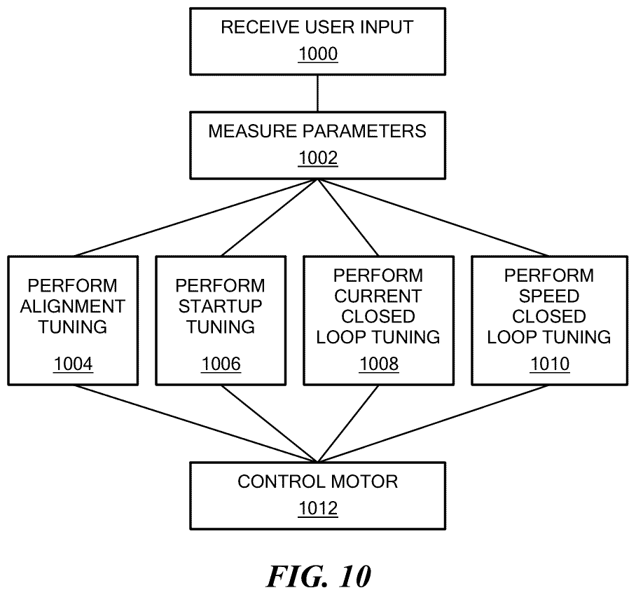

FIG. 10 shows an example sequence of steps for automatically tuning a FOC controller with user input. In step 1000, user input is received for various parameters that may be used for automatic tuning of the controller. In step 1002, motor parameters, such as phase resistance and phase inductance, are measured. A series of tuning processes can be performing in parallel, in serial, or a combination thereof. In step 1004, alignment tuning is performed. In step 1006, startup tuning is performed. In step 1008, current closed loop is performed. In step 1010, speed closed loop tuning is performed. In step 1012 the motor can be controlled by the FOV controller that operates after the various tuning procedures for enhanced motor performance.

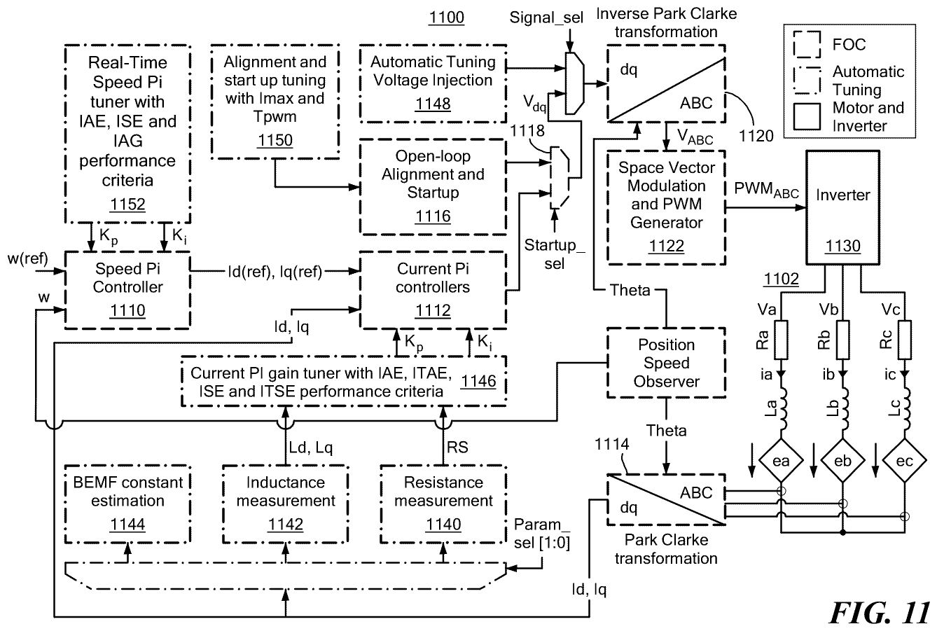

FIG. 11 shows an example implementation of an example system having an FOC controller 1100 with automatic tuning controlling a three-phase motor 1102. In the illustrated embodiment, example portions of the system are indicated as FOC, automatic tuning, and motor and inverter. It is understood that the motor, inverter and FOC components are well known and understood in the art. The FOC portion includes the Park and Clarke transformation and its inverse. As is well known, the Clarke transform converts vectors in the ABC reference frame to the xvz reference frame, which may also be referred to as the αβγ reference frame. The Park transform converts vectors in the xyz reference frame to the dqz reference frame by rotating a vector's reference frame at an arbitrary frequency.

In the illustrated embodiment, the FOC portion of the system includes a speed PI controller 1110 that receives a reference input and outputs reference id(ref) and iq(ref) values to a current PI controller 1112, which also receives the id and iq current from the output of the Park Clarke transformation module 1114, which receives currents from each of the motor phases ABC.

An open-loop alignment and start up module 1116 provide an output to a multiplexer 1118 along with an output of the current PI controller 1112. The output of the multiplexer 1118 is provided to an inverse Park Clarke transformation module 1120 for converting from d, g, to ABC format for processing by a space vector modulation and PWM generator 1122.

An inverter 1130 coupled to the motor 1112 receives the ABC PWM signals and generates signals for each motor phase.

As described above, the system can perform a resistance measurement 1140, an inductance measurement 1142, and a BEMF estimation 1144, all of which can be provided to a current PI gain tuner module 1146, which includes IAE, ITAE, ISE, and ITSE performance criteria. The PI gain tuner module 1146 outputs Kp and Ki values to the current PI controller 1112.

An automatic tuning voltage injection module 1148, as described above, provides an output that is selectively provided to the inverse Park Clarke transformation module 1120.

An alignment and startup tuning module 1150 with Imax and Tpwm, which is described above, provides outputs to the open loop alignment and startup module 1116.

A speed PI tuner module 1152, which is described above, with IAE, ISE, and IAG performance criteria, provides Kp and Ki values to the speed PI controller 1110.

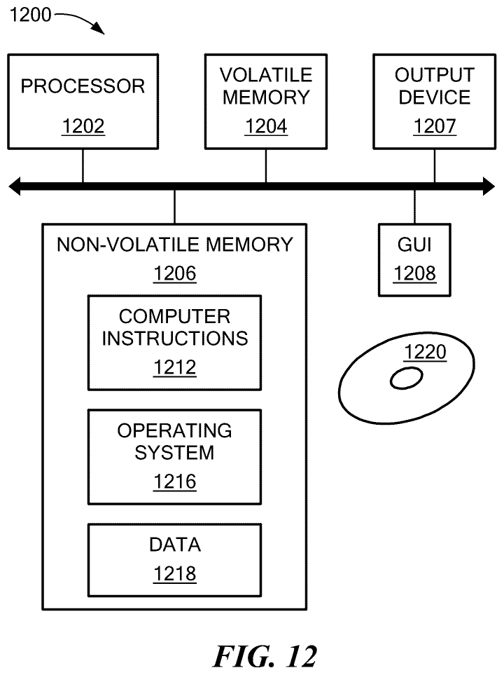

FIG. 12 shows an exemplary computer 1200 that can perform at least part of the processing described herein. The computer 1200 includes a processor 1202, a volatile memory 1204, a non-volatile memory 1206 (e.g., hard disk), an output device 1207 and a graphical user interface (GUI) 1208 (e.g., a mouse, a keyboard, a display, for example). The non-volatile memory 1206 stores computer instructions 1212, an operating system 1216 and data 1218. In one example, the computer instructions 1212 are executed by the processor 1202 out of volatile memory 1204. In one embodiment, an article 1220 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable embedded processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method of automatically tuning a controller for a field-oriented control (FOC) electric motor, comprising:
receiving user input for parameters for tuning the controller;
measuring phase resistance and phase inductance of the motor; and
automatically tuning the controller for at least one type of tuning based on the user input and the measured phase resistance and phase inductance of the motor.

2. The method according to claim 1, wherein the at least one type of tuning includes alignment tuning.

3. The method according to claim 1, wherein the at least one type of tuning includes startup tuning.

4. The method according to claim 1, wherein the at least one type of tuning includes current closed loop tuning.

5. The method according to claim 1, wherein the at least one type of tuning includes speed closed loop tuning.

6. The method according to claim 1, further including estimating a BEMF constant Ke for the motor using at least one of the parameters received as user input.

7. The method according to claim 6, further including measuring the phase resistance and phase inductance of the motor prior to tuning a current loop for the motor, and estimating the constant Ke during tuning of a speed loop of the motor.

8. The method according to claim 1, wherein the receiving user input for the parameters includes receiving a rated motor speed.

9. The method according to claim 1, wherein the receiving user input for the parameters includes receiving a rated current for the motor.

10. The method according to claim 1, wherein the receiving user input for the parameters includes a DC bus voltage for the motor.

11. The method according to claim 1, wherein the receiving user input for the parameters includes receiving a resistance of a shunt resistor.

12. The method according to claim 1, wherein the receiving user input for the parameters includes receiving an acceleration factor for the motor.

13. The method according to claim 1, wherein the receiving user input for the parameters includes receiving a deceleration factor for the motor.

14. The method according to claim 1, wherein the at least one type of tuning includes alignment tuning, startup tuning, current closed loop tuning, and speed closed loop tuning.

15. The method according to claim 1, wherein measuring the phase resistance includes injecting a DC voltage into a d-axis of the motor at a standstill and measuring d-axis current.

16. The method according to claim 1, wherein measuring the phase inductance includes measuring motor current response to injection of a sine waveform into a d-axis.

17. The method according to claim 16, wherein the sine waveform has a plurality of non-harmonic frequencies.

18. The method according to claim 1, wherein the at least one type of tuning includes alignment tuning, wherein the alignment tuning is a function of rated current of the motor, and wherein the alignment tuning includes tuning of an AC alignment frequency.

19. The method according to claim 1, wherein the at least one type of tuning includes startup tuning, and wherein the start up tuning includes tuning a startup start frequency and a startup end frequency.

20. The method according to claim 1, wherein the at least one type of tuning includes current closed loop tuning, and further including using performance assessment criteria (PAC) for comparing an ideal current closed loop response with a current closed loop response having varying parameters.

21. The method according to claim 1, wherein the at least one type of tuning includes speed closed loop tuning, and further including determining a gain factor for speed control.

22. The method according to claim 21, further including using a cost function to determine the gain factor.

23. The method according to claim 22, wherein the cost function is configured to find the gain factor for PI control.

24. The method according to claim 1, wherein voltage injection is used to estimate the phase resistance and the phase inductance of the motor.

25. A system to automatically tune a controller for a field-oriented control (FOC) electric motor, comprising:
memory and at least one processor configured to:
receive user input for parameters for tuning the controller;
measure phase resistance and phase inductance of the motor; and
automatically tune the controller for at least one type of tuning based on the user input and the measured phase resistance and phase inductance of the motor.

26. The system according to claim 25, wherein the at least one type of tuning includes alignment tuning, startup tuning, current closed loop tuning, and/or speed closed loop tuning.

27. The system according to claim 26, wherein the system is further configured to estimate a BEMF constant Ke for the motor using at least one of the parameters received as user input.

28. The system according to claim 26, wherein the user input for the parameters includes a rated motor speed, a rated current for the motor, a DC bus voltage for the motor, a resistance of a shunt resistor, an acceleration factor for the motor, and/or a deceleration factor for the motor.

29. The system according to claim 25, wherein the system is configured to measure the phase resistance by injecting a DC voltage into a d-axis of the motor at a standstill and measuring d-axis current.

30. The system according to claim 25, wherein the system is configured to measure the phase inductance by measuring motor current response to injection of a sine waveform into a d-axis.

31. The system according to claim 25, wherein the at least one type of tuning includes alignment tuning, wherein the alignment tuning is a function of rated current of the motor, and wherein the alignment tuning includes tuning of an AC alignment frequency.

32. The system according to claim 25, wherein the at least one type of tuning includes startup tuning, and wherein the start up tuning includes tuning a startup start frequency and a startup end frequency.

33. The system according to claim 25, wherein the at least one type of tuning includes current closed loop tuning, and wherein the system is further configured to use performance assessment criteria (PAC) for comparing an ideal current closed loop response with a current closed loop response having varying parameters.

34. The system according to claim 25, wherein the at least one type of tuning includes speed closed loop tuning, and further including determining a gain factor for speed control.

35. The system according to claim 25, wherein voltage injection is used to estimate the phase resistance and the phase inductance of the motor.
